(19) United States
(12) Patent Application Publication
(10) Pub. No.: US 2008/0253447 A1
(43) Pub. Date: Oct. 16, 2008

(54) Video Transcoding with Selection of Data Portions to be Processed

(75) Inventors: Stephen Rodney Cumpson, Eindhoven (NL); Adrianus Johannes Maria Denissen, Eindhoven (NL); Wilhelmus Hendrikus Alfonsus Bruls, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/570,505

(22) PCT Filed: Jun. 17, 2005
(86) PCT No.: PCT/IB05/51994

§ 371 Date: Dec. 13, 2006

(30) Foreign Application Priority Data
Jun. 21, 2004 (EP) 04300387.0

(51) Int. Cl. H04N 7/26; H04N 7/32

(52) U.S. Cl. 375/240.03; 375/240.01; 375/240.12; 375/E07.198

(57) ABSTRACT

The invention relates to an apparatus comprising:
processing means (18) for monitoring an input signal (20) so as to identify portions (22) of said input signal (20) having a bit rate greater than a predetermined threshold value (TH),
a transcoding module for transcoding said portions (22) so as to reduce their bit rate under said threshold value (TH).

### FIELD OF THE INVENTION

This invention relates to a system and method for selectively transcoding a digital signal for use in, for example, consumer electronic devices capable of accepting digital content with a wide range of encoded bit rates.

### BACKGROUND OF THE INVENTION

With the advent of digital video products and services, digital video signals are becoming ever present and drawing more attention in the market place. Because of the limitations in digital signal storage capacity and in network and broadcast bandwidth limitations, compression of digital video signals has become paramount to video signal storage and transmission. As a result, many standards for compression and encoding of digital video signals have been promulgated, including the MPEG, MPEG-1 and MPEG-2 standards for video encoding. These standards specify the form of the encoded digital video signals and how such signals are to be decoded for presentation to a viewer. However, significant discretion is left as to how the digital video signals are to be transformed from a native, uncompressed format to the specified encoded format. As a result, many different digital video signal encoders currently exist and many approaches are used to encode digital video signals with varying degrees of compression achieved.

Transcoding is herein understood to mean the operation of converting a stream of data, for example a video stream, having a given bit rate into another stream of data having a different bit rate. The present invention is particularly suitable for transcoding data streams in conformity with the MPEG standard (where “MPEG” is an acronym for “Moving Picture Experts Group”, which is a group of experts of the International Standardization Organisation (ISO) established in 1990 and which has adopted this standard for transmitting and/or storing animated images, which standard has been published in numerous documents by the ISO).

Transcoding may occur in situations where a first signal transport system interfaces a second signal transport system.

In a first example, if an input MPEG compressed video signal at 9 Mbits/second (such as transmitted by a satellite) must be relayed at a cable head end via a communication channel having a limited bandwidth capacity, the cable head-end will transcode this input signal to a lower bit rate fitting said limited bandwidth, for example at 5 Mbits/second.

In a second example, if an input MPEG compressed video signal broadcasted according to Digital Video Broadcast (DVD), i.e. a video signal possibly above 10 Mbits/second, must be archived on a DVD (Digital Versatile Disc), i.e. on a medium limited to a maximum video bit rate of 9.8 Mbits/second, this input signal must be transcoded to a lower bit rate fitting said limited bandwidth.

Transcoding is costly in terms of time and in terms of processor usage, since the entire input signal is basically first decoded and then re-encoded to achieve the required bit-rate throughout. Alternatively, the input signal can be partially transcoded in performing the processing on block of differential pixels instead of performing on decoded blocks of pixels, but such a process still applies to the entire input signal, then also leading to an expensive solution.

### OBJECT AND SUMMARY OF THE INVENTION

It is an object of the present invention to provide an improved apparatus and method for selectively transcoding an incoming digital signal, in which the time taken to perform such transcoding, and the processor usage required therefore, is reduced relative to prior art arrangements.

The apparatus according to the invention comprises
processing means for monitoring an input signal so as to identify portions of said input signal having a bit rate greater than a predetermined threshold value,
a transcoding module for transcoding said portions so as to reduce their bit rate under said threshold value.

The method according to the invention comprises the steps of:
monitoring an input signal so as to identify portions of said input signal having a bit rate greater than a predetermined threshold value,
transcoding said portions so as to reduce their bit rate under said threshold value.

Since the transcoding is only applied to identified portions, not only this apparatus requires limited processing means, but it also performs faster.

These and other aspects of the present invention will be apparent from, and elucidated with reference to, the embodiment described herein.

### BRIEF DESCRIPTION OF THE DRAWINGS

An embodiment of the present invention will now be described by way of example only and with reference to the accompanying drawings, in which:

FIG. 1 is a known schematic transcoding arrangement according to an exemplary embodiment of the present invention,

FIG. 2 is a schematic block diagram illustrating an arrangement for identifying portions of an MPEG video stream having a bit rate that is higher than some predetermined threshold value,

FIG. 3 illustrates schematically a video file obtained as a result of the arrangement of FIG. 2,

FIG. 4 illustrates schematically the process of reducing the bit rate of portions of the video file having a bit rate that is too high,

FIG. 5 is a schematic flow diagram illustrating an iterative binary search method for use in the process of FIG. 4 to optimise the video quality with respect to the maximum allowed bit rate,

### DETAILED DESCRIPTION OF THE INVENTION

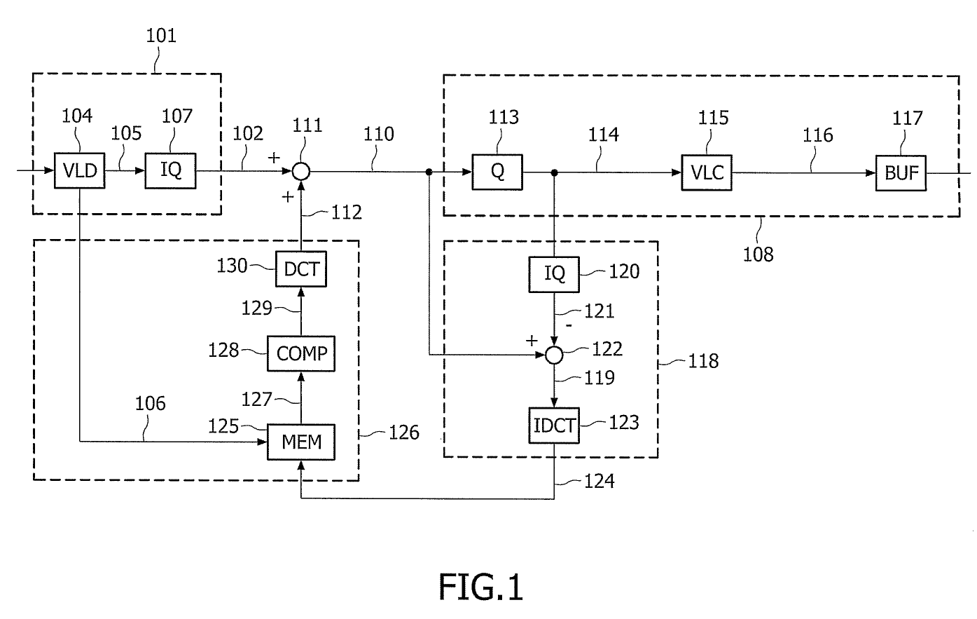

FIG. 1 depicts a known transcoding arrangement comprising at least an error decoding step 101 for generating a decoded data signal 102 from a current input coded video signal 103. This error decoding step 101 performs partial decoding of the input video signal 103 since only a reduced number of data type comprised in said input signal are decoded. This step comprises a variable length decoding (VLD) denoted by reference numeral 104 of at least DCT coefficients and motion vectors comprised in signal 103. This step consists of an entropy decoding (e.g. by means of an inverse look-up table comprising Huffman codes) for obtaining decoded DCT coefficients 105 and motion vectors 106. In series with said step 104, an inverse quantisation (IQ) denoted 107 is performed on said decoded coefficients 105 for generating said decoded data signal 102. The inverse quantisation 107 mainly consists of multiplying said DCT decoded coefficients 105 by a quantisation factor of said input signal 103. In most cases, this inverse quantisation 107 is performed at the macroblock level because said quantisation factor may change from one macroblock to another. The decoded signal 102 comprises data in the frequency domain.

This transcoding arrangement also comprises a re-encoding step 108 for generating an output video signal 109 corresponding to the signal resulting from the transcoding of said input video signal 103. This video signal 109 is designated as the base video signal. Signal 109 is compliant with the MPEG-2 video standard as input signal 103. Said re-encoding 108 acts on an intermediate data signal 110 which results from the addition, by means of the adding sub-step 11, of said decoded data signal 102 to a modified motion-compensated signal 112. Said re-encoding step 108 comprises in series a quantisation denoted 113. This quantisation 113 consists of dividing DCT coefficients in signal 110 by a new quantisation factor Q, for generating quantised DCT coefficients 114. Such a new quantisation factor characterises the modification performed by the transcoding of said input coded video signal 103, because, for example, a larger quantisation factor than the one used in step 107 may result in a bit rate reduction of said input coded video signal 103. In series with said quantisation 113, a variable-length coding (VLC) denoted 115 is applied on said coefficients 114 for obtaining entropy-coded DCT coefficients 116. Similarly to VLD processing, VLC processing consists of a look-up table for defining a Huffman code to each coefficient 114. Then, coefficients 116 are accumulated in a buffer (BUF) denoted 117, as well as motion vectors 106 (not depicted), for constituting transcoded frames carried by said base video signal 109.

This arrangement also comprises a reconstruction step 118 for generating the coding error 119, in the frequency domain, of said base video signal 109. This reconstruction step allows quantifying of the coding error introduced by the quantisation 113. Such a coding error of a current transcoded video frame is taken into account, during a motion compensation step, for the transcoding of the next video frame for avoiding quality drift from frame to frame in the base video signal 109. Said coding error 119 is reconstructed by means of an inverse quantisation (IQ) denoted as 120 and performed on signal 114, resulting in signal 121. A subtracting sub-step 122 is then performed between signals 110 and 121, resulting in said coding error 119 in the DCT domain, i.e. in the frequency domain. Such a coding error 119 corresponds to the difference between said input coded video signal 103 and the base video signal 109. Said coding error 119 in the frequency domain is passed through an inverse discrete cosine transform (IDCT) denoted as 123 for generating the corresponding coding error 124 in the pixel domain.

This arrangement also comprises a motion compensation sub-step 126 for generating said motion compensated signal 112, from a coding error stored in memory (MEM) denoted 125 and relative to a previous transcoded video frame carried by signal 109. Memory 125 comprises at least two sub-memories: the first one dedicated to the storage of the modified coding error 124 relative to a video frame being transcoded, and the second one dedicated to the storage of the modified coding error 124 relative to a previous transcoded video frame. First, motion compensation 128 (COMP) is performed in a prediction step on the content of said second sub-memory accessible by signal 127. The prediction step consists of calculating a predicted signal 129 from said stored coding error 127: The predicted signal, also called motion-compensated signal, corresponds to the part of the signal stored in said memory device 125 that is pointed by the motion vector 106 relative to the part of the input video signal 102 being transcoded. As is known to those skilled in the art, said prediction is usually performed at the MB level, which means that for each input MB carried by signal 102, a predicted MB is determined and further added by adding sub-step 111 in the DCT domain to said input MB for attenuating quality drift from frame to frame. As the motion-compensated signal 129 is in the pixel domain, it is passed through a DCT step 130 for generating said motion-compensated signal 112 in the DCT domain.

In accordance with the present invention, prior to the transcoding step, the input signal is monitored so as to identify portions of said input signal having a bit rate greater than a predetermined threshold value. Only said portions are therefore transcoded to a lower bit rate. To this end, a transcoding module implementing the arrangement described according to FIG. 1 may be advantageously used.

For example, if a DVB signal must be archived on a DVD medium, said threshold is set to the maximum bandwidth allowed by said DVD medium, i.e. 9.8 Mbits/second.

Advantageously, to facilitate the transcoding of portions identified as having a bit rate greater than said threshold, said portions are started by an intra-coded picture (i.e. pictures which are not coded with reference to previous or future pictures) of a GOP (Group of Pictures), and are ended by a picture corresponding to the last picture of a GOP.

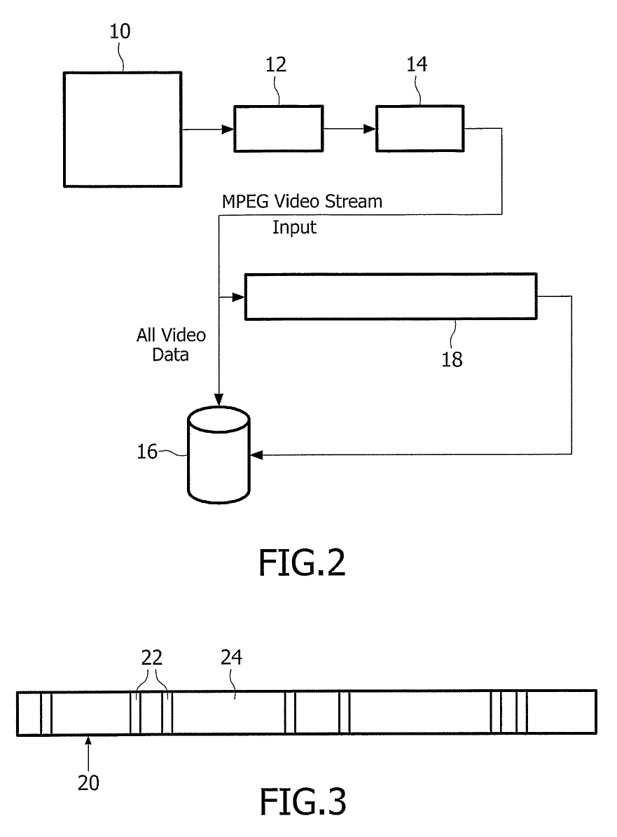

FIG. 2 of the drawings illustrates schematically an arrangement for identifying portions of an MPEG video stream having a bit rate which is too high (i.e. greater than some predetermined threshold value determined by the input device(s)).

An incoming signal is received by an antenna or satellite cable 10 and passed through a tuner 12 to a demultiplexing device 14 which outputs an MPEG video stream input. All of this resultant video data is, in this case, input to a storage device 16. In addition, the video data is passed through a local bit rate detector 18, which generates pointers to portions of the video data having a bit rate which is too high. It will be appreciated that such portions tend to amount to no more than a few percent of the complete video signal.

The video signal 20 is illustrated schematically in FIG. 3 of the drawings, said video signal comprising either portions 22 having a bit rate that is too high (i.e. whose bit rate is above the threshold), and portions 24 having a suitable bit rate (i.e. whose bit rate is below the threshold).

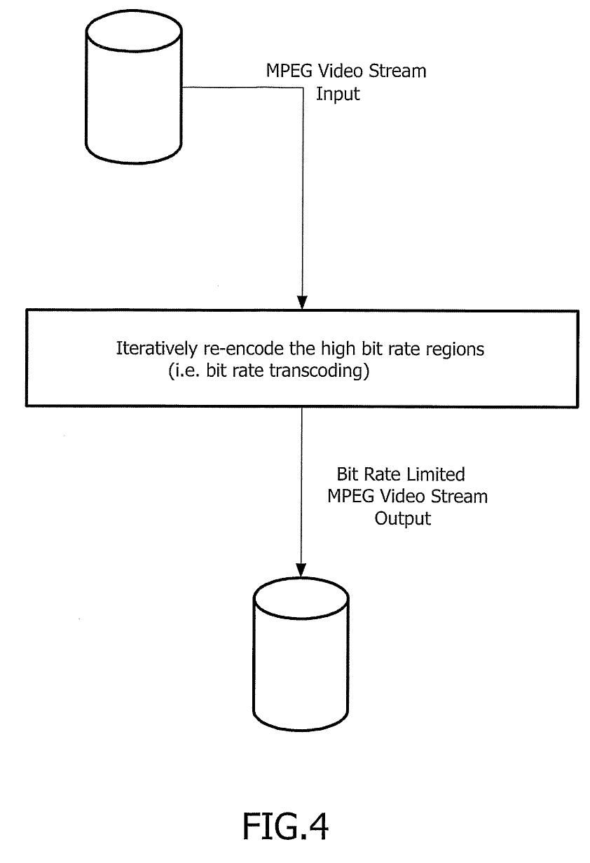

Referring additionally to FIG. 4 of the drawings, the input MPEG video stream 20 (including the pointers to portions 24 having a bit rate that is too high) is read, and the high bit rate portions 24 thereof are iteratively re-encoded (i.e. transcoded) so as to generate an output signal whose bit rate is permanently above the bit rate threshold.

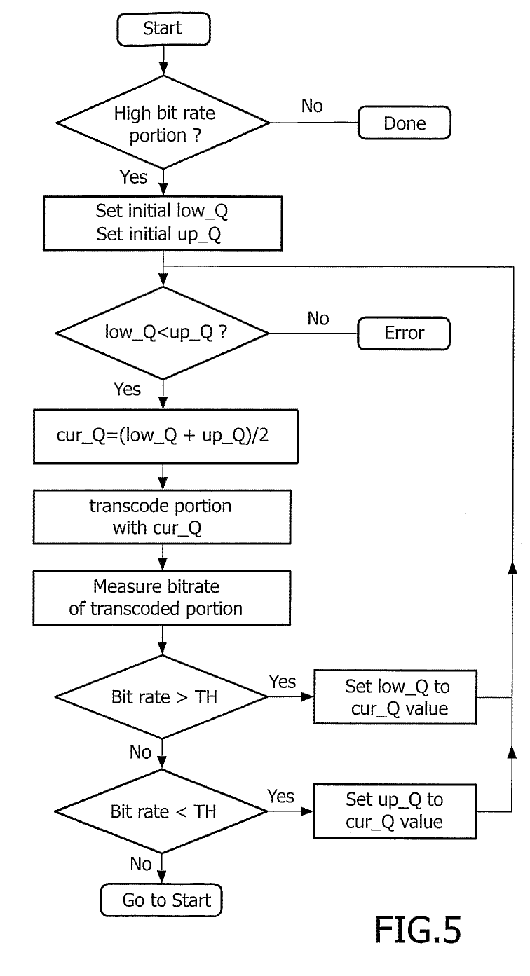

Referring to FIG. 5 of the drawings, an exemplary process for iteratively transcoding the high bit rate portions is illustrated schematically in the form of a flow chart.

If a transcoding arrangement as depicted by FIG. 1 is used, the high bit rate portions are transcoded in acting on the quantisation factor Q of the quantization block referred to as 113.

First, a current quantisation factor cur_Q is determined by setting an initial lower quantisation factor low_Q and an initial upper quantisation factor up_Q, adding these two values together and dividing by 2. Then, a high bit rate portion is transcoded with this current quantisation factor cur_Q.

The bit rate of the transcoded region is then determined.

If the resultant bit rate of the transcoded region of the video stream is too high (relative to a predetermined bit rate threshold value TH), the lower quantisation factor low_Q is set to the value of the current quantisation factor cur_Q, the upper quantisation factor up_Q remains the same, a new (higher) current quantisation factor cur_Q is calculated and the transcoding process is repeated using this new current quantisation factor cur_Q.

On the contrary, if the bit rate of the transcoded region of the video stream is determined to be too low (relative to the predetermined bit rate threshold value TH), the upper quantisation factor up_Q is set to the value of the current quantisation factor cur_Q, the lower quantisation factor low_Q remains the same, a new (lower) current quantisation factor cur_Q is calculated and the transcoding process is repeated using this new current quantisation factor cur_Q. This process is repeated until the resultant bit rate of the transcoded region is determined not to be too high or too low.

To avoid that the bit rate becomes too low compared to the predetermined bit rate threshold value TH, it may be decided that the bit rate is considered too low only if it is below a few percents of said threshold TH.

There are several suitable methods for determining the bit rate of the incoming digital signal such as an MPEG video stream. For example, the number of incoming bits to a FIFO (First-In First-Out) buffer within a time period At can be determined. Alternatively, a simple estimate can be obtained by studying the Elementary Stream (i.e. the video stream) for Group of Picture (GOP) headers. A GOP has a structure of a fixed number of fixed duration video frames. Within the MPEG stream there is also a time base based on a Clock Reference which can be studied for timing information. It is also possible to measure the number of fixed sized packets making up the GOP. Thus, time and data size can be obtained, from which the bit rate can be estimated. Other suitable methods will be apparent to a person skilled in the art.

Thus, the system according to an exemplary embodiment of the present invention is arranged and configured to monitor the incoming digital signal during recording (in the case of, for example, a DVD archiving application), and identify areas where higher bit rates are seen. This can be classified as extra characteristic point information. Such information is invaluable to the transcoder as it can immediately limit the amount of processing work that needs to be performed, because only streams of data having a bit rate greater than some predetermined threshold value (set by the maximum bit rate capacity of the device to which the incoming digital signal is required to be recorded) will need to be transcoded. As a result, transcoding is only performed to decrease the input bit rate (e.g. under 9.8 Mbits/second if DVD archiving application is concerned) only in these detected temporal areas.

Experimental measurements in the DVD archiving context referred to above indicate that for less than 5% of the time, the bit rate can be considered to be high. Such a system could perform transcoding at (at least) 20 times real-time rates and with 20 times less processor usage. The method and system of the present invention are ideal for format conversion or fast archiving functionality in general, and are not limited to the DVD archiving application quoted herein.

The apparatus and method may be advantageously implemented in a transcoder, or in a media player system such as a DVD+RW/HDD combi recorder with fast archiving functionality, networked HDD recorder capable of format conversions, and digital input enabled storage devices generally.

The invention may be implemented by means of hardware, such as a signal processor connected to a memory for storing code instructions implementing the various steps of the method according to the invention.

It should be noted that the above-mentioned embodiments illustrate rather than limit the invention, and that those skilled in the art will be capable of designing many alternative embodiments without departing from the scope of the invention as defined by the appended claims. In the claims, any reference signs placed in parentheses shall not be construed as limiting the claims. The word “comprising” and “comprises”, and the like, does not exclude the presence of elements or steps other than those listed in any claim or the specification as a whole. The singular reference of an element does not exclude the plural reference of such elements and vice-versa.

The mere fact that certain measures are recited in mutually different dependent claims does not indicate that a combination of these measures cannot be used to advantage.

1. Apparatus comprising
processing means for monitoring an input signal to identify portions of said input signal having a bit rate greater than a predetermined threshold value,
a transcoding module for transcoding said portions so to reduce the bit rate under said threshold value.

2. Apparatus according to claim 1, wherein said transcoding module comprises iterative processing means applied to said portions.

3. Apparatus according to claim 1, wherein said transcoding module comprises a quantization block for quantifying DCT coefficients composing said portions.

4. Apparatus according to claim 2, wherein each of said portions is started by an intra-coded picture of a group of pictures, and is ended by a picture corresponding to the last picture of a group of pictures.

5. A method comprising the steps of
monitoring an input signal to identify portions of said input signal having a bit rate greater than a predetermined threshold value, and
transcoding said portions so as to reduce the bit rate under said threshold value.

6. A transcoder apparatus comprising
processing means for monitoring an input signal to identify portions of said input signal having a bit rate greater than a predetermined threshold value,
a transcoding module for transcoding said portions to reduce their the bit rate under said threshold value.

7. A media player system for receiving an input signal, said media player system comprising
processing means for monitoring an input signal to identify portions of said input signal having a bit rate greater than a predetermined threshold value,
a transcoding module for transcoding said portions to reduce the bit rate under said threshold value.
